(19) United States
(12) Patent Application Publication
(10) Pub. No.: US 2006/0290598 A1
(43) Pub. Date: Dec. 28, 2006

(54) Plasma display apparatus and method of driving the same

(75) Inventor: Seonghak Moon, Seoul (KR)

Correspondence Address: FLESHNER & KIM, LLP, P.O. BOX 221200, CHANTILLY, VA, 20153, US

(73) Assignee: LG Electronics, Inc.

(21) Appl. No.: 11/471,581

(22) Filed: Jun. 21, 2006

(30) Foreign Application Priority Data
Jun. 24, 2005 (KR) 10-2005-0055323

(51) Int. Cl. G09G 3/28

(52) U.S. Cl. 345/60

(57) ABSTRACT

A plasma display apparatus is disclosed. The plasma display apparatus includes a plasma display panel including a scan electrode and a data electrode, and a scan driver for supplying a scan bias voltage and a scan voltage to the scan electrode. Magnitudes of the scan bias voltage and the scan voltage supplied in an address period of a first subfield are different from magnitudes of the scan bias voltage the scan voltage supplied in an address period of a second subfield, respectively.

This Non-provisional application claims priority under 35 U.S.C. § 119(a) on Patent Application No. 10-2005-0055323 filed in Korea on Jun. 24, 2005 the entire contents of which are hereby incorporated by reference.

### BACKGROUND OF THE INVENTION

1. Field of the Invention

This document relates to a display apparatus, and more particularly, to a plasma display apparatus and a method of driving the plasma display apparatus.

2. Description of the Background Art

A plasma display apparatus comprises a plasma display panel for displaying an image and a driver for driving the plasma display panel. The driver is attached on a rear surface of the plasma display panel.

The plasma display panel comprises a front panel, a rear panel, and barrier ribs formed between the front panel and the rear panel. The barrier ribs form discharge cells. Each of the discharge cells is filled with an inert gas containing a main discharge gas such as neon (Ne), helium (He) or a Ne—He gas mixture and a small amount of xenon (Xe). The plurality of discharge cells form one pixel. For example, a red (R) discharge cell, a green (G) discharge cell and a blue (B) discharge cell form one pixel.

When a high frequency voltage is supplied to the discharge cells to generate a discharge, the inert gas within the discharge cells generates vacuum ultraviolet rays. The vacuum ultraviolet rays emit a phosphor formed between the barrier ribs such that an image is displayed.

The plasma display panel comprises a plurality of electrodes, for example, a scan electrode, a sustain electrode and a data electrode. Drivers for supplying a driving voltage to each of the plurality of electrodes of the plasma display panel are connected to the scan electrode, the sustain electrode and the data electrode, respectively.

When driving the plasma display panel, the drivers supply a reset pulse in a reset period, a scan pulse in an address period, and a sustain pulse in a sustain period to the plurality of electrodes of the plasma display panel, such that the image is displayed. Since the above-described plasma display apparatus can be manufactured to be thin and light, the plasma display apparatus has been considered as a display apparatus.

When driving the plasma display apparatus by supplying the above pulses to the electrodes, driving reliability of the plasma display apparatus is reduced by various causes.

For example, driving conditions change by various causes such as an environmental cause affecting the plasma display panel, a distance between the electrodes and the drivers, a distance between the electrodes, a difference between supply time points of each of the driving pulses. The change in the driving conditions generates an erroneous discharge and reduces driving stability.

A research for improving the driving stability of the plasma display apparatus have been continually studied in consideration of the above-described problems.

### SUMMARY OF THE INVENTION

Accordingly, an object of the present invention is to solve at least the problems and disadvantages of the background art.

According to an aspect, there is provided a plasma display apparatus comprising a plasma display panel comprising a scan electrode and a data electrode, and a scan driver for supplying a scan bias voltage and a scan voltage to the scan electrode, wherein magnitudes of the scan bias voltage and the scan voltage supplied in an address period of a first subfield are different from magnitudes of the scan bias voltage and the scan voltage supplied in an address period of a second subfield, respectively.

According to another aspect, there is provided a plasma display apparatus comprising a plasma display panel comprising a scan electrode and a data electrode, and a driver for controlling a voltage difference between a scan voltage or a scan bias voltage supplied to the scan electrode and a data voltage supplied to the data electrode in an address period of a first subfield to be different from a voltage difference between a scan voltage or a scan bias voltage supplied to the scan electrode and a data voltage supplied to the data electrode in an address period of a second subfield.

According to still another aspect, there is provided a plasma display apparatus comprising a plasma display panel comprising a scan electrode and a data electrode, a scan driver for supplying a scan bias voltage and a scan voltage to the scan electrode, wherein magnitudes of the scan bias voltage and the scan voltage supplied during the address period of the first subfield are different from magnitudes of the scan bias voltage and the scan voltage supplied in the address period of the second subfield depending on an APL, and a data driver for supplying a data voltage to the data electrode, wherein a magnitude of the data voltage supplied during the address period of the first subfield is different from a magnitude of the data voltage supplied during the address period of the second subfield depending on the APL.

According to further another aspect, there is provided a method of driving a plasma display apparatus comprising a scan electrode and a data electrode, comprising controlling a voltage difference between a scan voltage or a scan bias voltage supplied to the scan electrode and a data voltage supplied to the data electrode in an address period of a first subfield to be different from a voltage difference between a scan voltage or a scan bias voltage supplied to the scan electrode and a data voltage supplied to the data electrode to in an address period of a second subfield.

### BRIEF DESCRIPTION OF THE DRAWINGS

The embodiment of the invention will be described in detail with reference to the following drawings in which like numerals refer to like elements.

FIG. 1 illustrates a plasma display apparatus according to an embodiment of the present invention;

FIG. 2 illustrates a structure of a plasma display panel of the plasma display apparatus according to the embodiment of the present invention;

FIG. 3 illustrates a method for representing gray scale of an image in the plasma display apparatus according to the embodiment of the present invention;

FIG. 4 illustrates a driver of the plasma display apparatus according to the embodiment of the present invention;

FIGS. 5a to 5d illustrate first to fourth examples of a driving waveform in the plasma display apparatus according to the embodiment of the present invention;

FIG. 6 illustrates a relationship between an APL (Average Picture Level) and the number of sustain signals in the plasma display apparatus according to the embodiment of the present invention; and

FIGS. 7a to 7d illustrate fifth to eighth examples of a driving waveform in the plasma display apparatus according to the embodiment of the present invention.

### DETAILED DESCRIPTION OF PREFERRED EMBODIMENTS

Preferred embodiments of the present invention will be described in a more detailed manner with reference to the drawings.

A plasma display apparatus according to an embodiment of the present invention comprises a plasma display panel comprising a scan electrode and a data electrode, and a scan driver for supplying a scan bias voltage and a scan voltage to the scan electrode, wherein a magnitude of the scan bias voltage supplied in an address period of a first subfield is different from a magnitude of the scan bias voltage supplied in an address period of a second subfield, and a magnitude of the scan voltage supplied in the address period of the first subfield is different from a magnitude of the scan voltage supplied in the address period of the second subfield.

A magnitude of the scan bias voltages and a magnitude of the scan voltages supplied during the address period of the first subfield may be different from a magnitude of the scan bias voltages and a magnitude of the scan voltages supplied during the address period of the second subfield depending on an average picture level (APL).

The plasma display apparatus may further comprise a signal conversion unit for converting an input image signal into a data signal for driving the plasma display panel, an APL unit for determining an APL depending on the data signal, and a voltage conversion unit for outputting the scan bias voltage and the scan voltage to the scan driver, wherein the magnitude of the scan bias voltage or scan voltage depends on the APL.

The voltage conversion unit may comprise a DC/DC converter.

A plasma display apparatus according to the embodiment of the present invention comprises a plasma display panel comprising a scan electrode and a data electrode, and a driver for controlling a voltage difference between a scan voltage or a scan bias voltage supplied to the scan electrode and a data voltage supplied to the data electrode in an address period of a first subfield to be different from a voltage difference between a scan voltage or a scan bias voltage supplied to the scan electrode and a data voltage supplied to the data electrode in an address period of a second subfield.

A magnitude of the difference between the scan voltage or the scan bias voltage and the data voltage in the address period of the first subfield, and a magnitude of the difference between the scan voltage or the scan bias voltage and the data voltage in the address period of the second subfield may depend on an APL.

A magnitude of the difference between the scan voltage or the scan bias voltage and the data voltage in the address period of the first subfield, and a magnitude of the difference between the scan voltage or the scan bias voltage and the data voltage in the address period of the second subfield may depend on a temperature.

A magnitude of the difference between the scan voltage or the scan bias voltage and the data voltage in the address period of the first subfield, and a magnitude of the difference between the scan voltage or the scan bias voltage and the data voltage in the address period of the second subfield may depend on the number of subfields in one frame.

A magnitude of the scan voltage supplied during the address period of the first subfield may equal to a magnitude of the scan voltage supplied during the address period of the second subfield, or a magnitude of the scan bias voltage supplied during the address period of the first subfield may equal to a magnitude of the scan bias voltage supplied during the address period of the second subfield.

A magnitude of the data voltage supplied during the address period of the first subfield may equal a magnitude of the data voltage supplied during the address period of the second subfield.

The plasma display apparatus may further comprise a signal conversion unit for converting an input image signal into a data signal for driving the plasma display panel, an APL unit for determining an APL depending on the data signal, and a voltage conversion unit for changing the voltage difference between the scan voltage or the scan bias voltage and the data voltage depending on the APL.

The voltage conversion unit may comprise a DC/DC converter.

A plasma display apparatus according to the embodiment of the present invention comprises a plasma display panel comprising a scan electrode and a data electrode, a scan driver for supplying a scan bias voltage and a scan voltage to the scan electrode, wherein a magnitude of the scan bias voltage supplied during the address period of the first subfield is different from a magnitude of the scan bias voltage supplied in the address period of the second subfield, and a magnitude of the scan voltage supplied in the address period of first subfield is different from a magnitude of the scan voltage supplied in the address period of second subfield depending on an APL, and a data driver for supplying a data voltage to the data electrode, wherein a magnitude of the data voltage supplied during the address period of the first subfield is different from a magnitude of the data voltage supplied during the address period of the second subfield depending on the APL.

A method of driving a plasma display apparatus comprising a scan electrode and a data electrode according to the embodiment of the present invention, comprises controlling a voltage difference between a scan voltage or a scan bias voltage supplied to the scan electrode and a data voltage supplied to the data electrode in an address period of a first subfield to be different from a voltage difference between a scan voltage or a scan bias voltage supplied to the scan electrode and a data voltage supplied to the data electrode to in an address period of a second subfield.

A magnitude of the difference between the scan voltage or the scan bias voltage and the data voltage in the address period of the first subfield, and a magnitude of the difference between the scan voltage or the scan bias voltage and the data voltage in the address period of the second subfield may depend on an APL.

A magnitude of the difference between the scan voltage or the scan bias voltage and the data voltage in the address period of the first subfield, and a magnitude of the difference between the scan voltage or the scan bias voltage and the data voltage in the address period of the second subfield may depend on a temperature.

A magnitude of the difference between the scan voltage or the scan bias voltage and the data voltage in the address period of the first subfield, and a magnitude of the difference between the scan voltage or the scan bias voltage and the data voltage in the address period of the second subfield may depend on the number of subfields in one frame.

A magnitude of the scan voltage supplied during the address period of the first subfield may equal to a magnitude of the scan voltage supplied during the address period of the second subfield, or a magnitude of the scan bias voltage supplied during the address period of the first subfield may equal to a magnitude of the scan bias voltage supplied during the address period of the second subfield.

A magnitude of the data voltage supplied during the address period of the first subfield may equal a magnitude of the data voltage supplied during the address period of the second subfield.

The method may further comprise calculating a gray level weight corresponding to an input image signal, and changing the difference between the scan voltage or the scan bias voltage and the data voltage depending on the gray level weight.

Hereinafter, exemplary embodiments of the present invention will be described in detail with reference to the attached drawings.

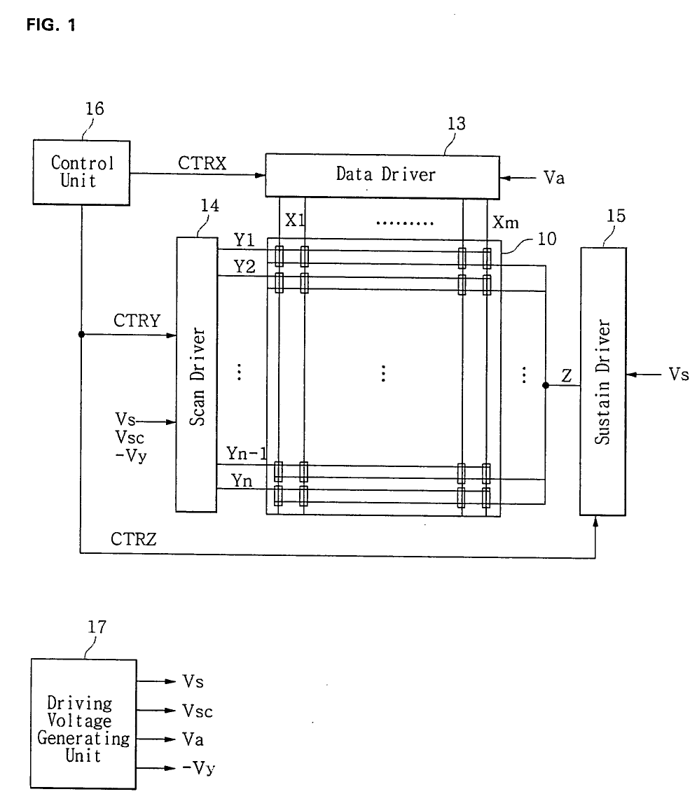

FIG. 1 illustrates a plasma display apparatus according to an embodiment of the present invention.

As illustrated in FIG. 1, the plasma display apparatus according to the embodiment of the present invention comprises a plasma display panel 10, on which an image is displayed by processing image data input from the outside, a data driver 13, a scan driver 14, a sustain driver 15, a control unit 16, and a driving voltage generating unit 17. The data driver 13 supplies data to data electrodes X1 to Xm formed in the plasma display panel 10. The scan driver 14 drives scan electrodes Y1 to Yn. The sustain driver 15 drives sustain electrodes Z being common electrodes. The control unit 16 controls the data driver 13, the scan driver 14 and the sustain driver 15. The driving voltage generating unit 17 supplies a necessary driving voltage to each of the drivers 13, 14 and 15.

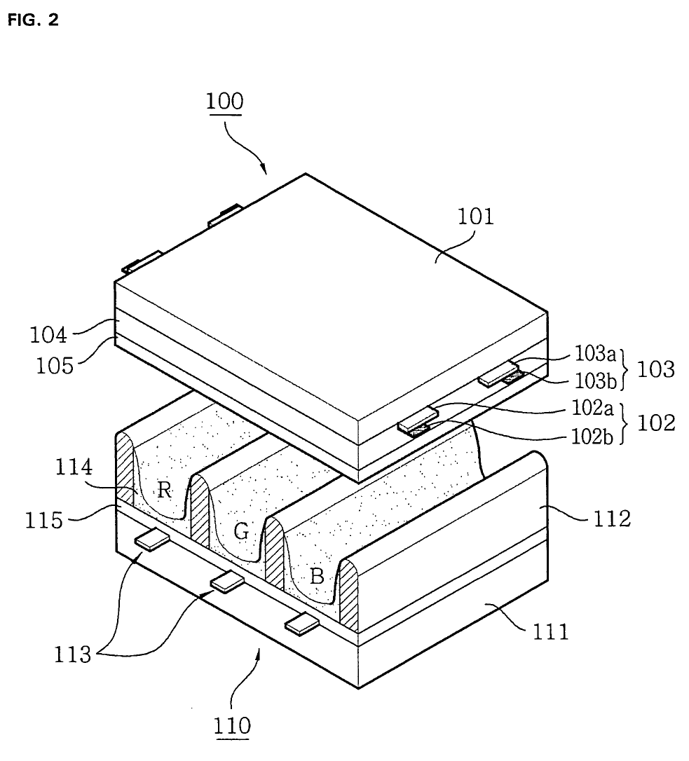

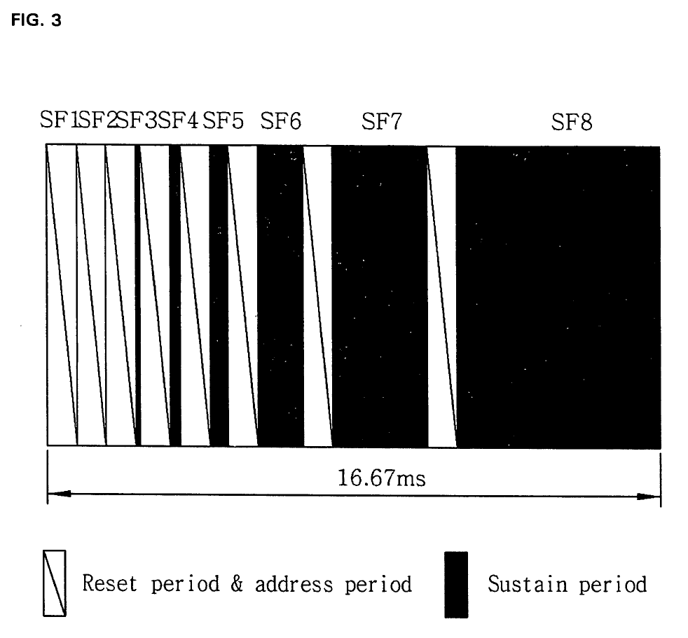

The following is a detailed description of a structure and a driving method of the plasma display panel, with reference to FIGS. 2 and 3.

FIG. 2 illustrates a structure of a plasma display panel of the plasma display apparatus according to the embodiment of the present invention.

As illustrated in FIG. 2, the plasma display panel comprises a front panel 100 and a rear panel 110 which are coupled in parallel to oppose to each other at a given distance therebetween. The front panel 100 comprises a front substrate 101 being a display surface and the rear panel 110 comprises a rear substrate 111 constituting a rear surface. A plurality of scan electrodes 102 and a plurality of sustain electrodes 103 are formed in pairs on the front substrate 101, on which an image is displayed, to form a plurality of maintenance electrode pairs. A plurality of data electrodes 113 are arranged on the rear substrate 111 to intersect the plurality of maintenance electrode pairs.

The scan electrode 102 and the sustain electrode 103 each comprise transparent electrodes 102a and 103a made of a transparent indium-tin-oxide (ITO) material and bus electrodes 102b and 103b made of a metal material. The scan electrode 102 and the sustain electrode 103 generate a mutual discharge within one discharge cell and maintain emissions of the discharge cells. The scan electrode 102 and the sustain electrode 103 are covered with one or more upper dielectric layers 104 for limiting a discharge current and providing insulation between the maintenance electrode pairs. A protective layer 105 with a deposit of MgO is formed on an upper surface of the upper dielectric layer 104 to facilitate discharge conditions.

A plurality of stripe-type or well-type barrier ribs 112 are arranged in parallel in the rear panel 110 to form a plurality of discharge spaces, that is, a plurality of discharge cells. The plurality of data electrodes 113 for performing an address discharge and generating vacuum ultraviolet rays are disposed in parallel with the barrier ribs 112. Red (R), green (G) and blue (B) phosphors 114 are coated on an upper surface of the rear panel 110 to emit visible light for displaying an image during the generation of the address discharge. A lower dielectric layer 115 for protecting the data electrodes 113 is formed between the data electrodes 113 and the phosphors 114.

The front panel 100 and the rear panel 110 thus formed are coalesced by a sealing process such that the plasma display panel is formed. Drivers for driving the scan electrode 102, the sustain electrode 103 and the data electrode 113 are adhered to the plasma display panel such that a plasma display apparatus is completed.

FIG. 3 illustrates a method for representing gray scale of an image in the plasma display apparatus according to the embodiment of the present invention.

As illustrated in FIG. 3, the plasma display apparatus is driven by dividing one frame into a plurality of subfields so that the image is displayed on the plasma display panel. Each of the subfields comprises a reset period for initializing all cells, an address period for selecting cells to be discharged, and a sustain period for representing gray scale depending on the number of discharges.

For example, in a case of representing 256-level gray scale, a frame period (16.67 ms) corresponding to 1/60 sec is divided into eight subfields SF1 to SF8. The eight subfields SF1 to SF8 each comprise a reset period, an address period, and a sustain period. The duration of the reset period in a subfield equals to the durations of the reset periods in the remaining subfields. The duration of the address period in a subfield equals to the durations of the address periods in the remaining subfields. The duration of the sustain period and the number of sustain signals supplied in the sustain period increase in a ratio of 2ⁿ (n=0, 1, 2, 3, 4, 5, 6, 7) in each of the subfields. As described above, since the duration of the sustain period changes in each of the subfields, gray scale of the image is represented by controlling the duration of the sustain period of each of the subfields, that is, the number of sustain discharges.

The explanation was given of an example of the structure of the plasma display panel and an example of the driving method for representing the image in the plasma display apparatus. Below, a description of the plasma display apparatus of FIG. 1 succeeds.

The plasma display apparatus of FIG. 1 according to the embodiment of the present invention comprises the plasma display panel 10, the drivers 13, 14, and 15, the control unit 16 and the driving voltage generating unit 17.

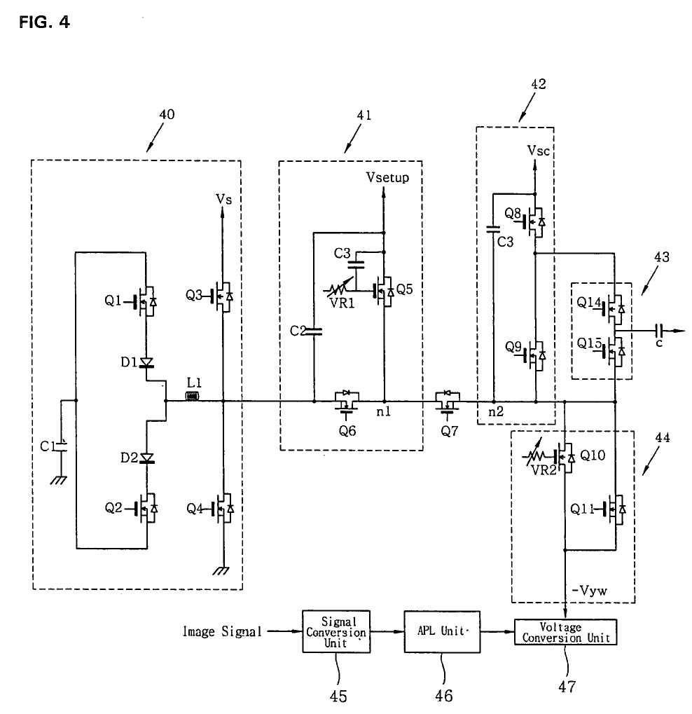

The drivers control a difference between a scan voltage or a scan bias voltage supplied to the scan electrodes Y1 to Yn and a data voltage supplied to the data electrodes X1 to Xn depending on the subfields. In other words, the difference between the scan voltage and the data voltage or the difference between the scan bias voltage and the data voltage is controlled depending on the subfields or an environmental factor of the plasma display panel such as an APL (Average Picture Level). This will be described below with reference to FIG. 4.

A front substrate (not shown) and a rear substrate (not shown) of the plasma display panel 10 are coalesced with each other at a given distance therebetween. On the front substrate, a plurality of electrodes, for example, the scan electrodes Y1 to Yn and the sustain electrodes Z are formed in pairs. On the rear substrate, the address electrodes X1 to Xm are formed to intersect the scan electrodes Y1 to Yn and the sustain electrodes Z.

The data driver 13 receives data, which is inverse-gamma corrected and error-diffused by an inverse gamma correction circuit (not shown) and an error diffusion circuit (not shown) and then mapped in accordance to a pre-set subfield pattern by a subfield mapping circuit (not shown). The data driver 13 supplies the data, which is sampled and latched under the control of the control unit 16, to the data electrodes X1 to Xm.

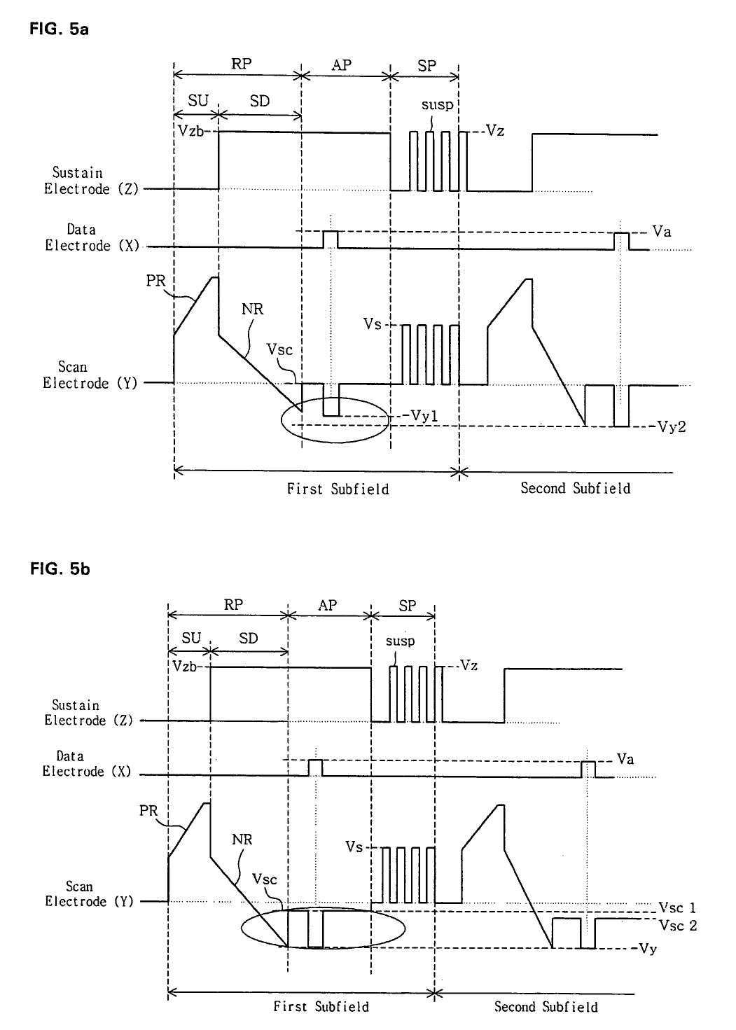

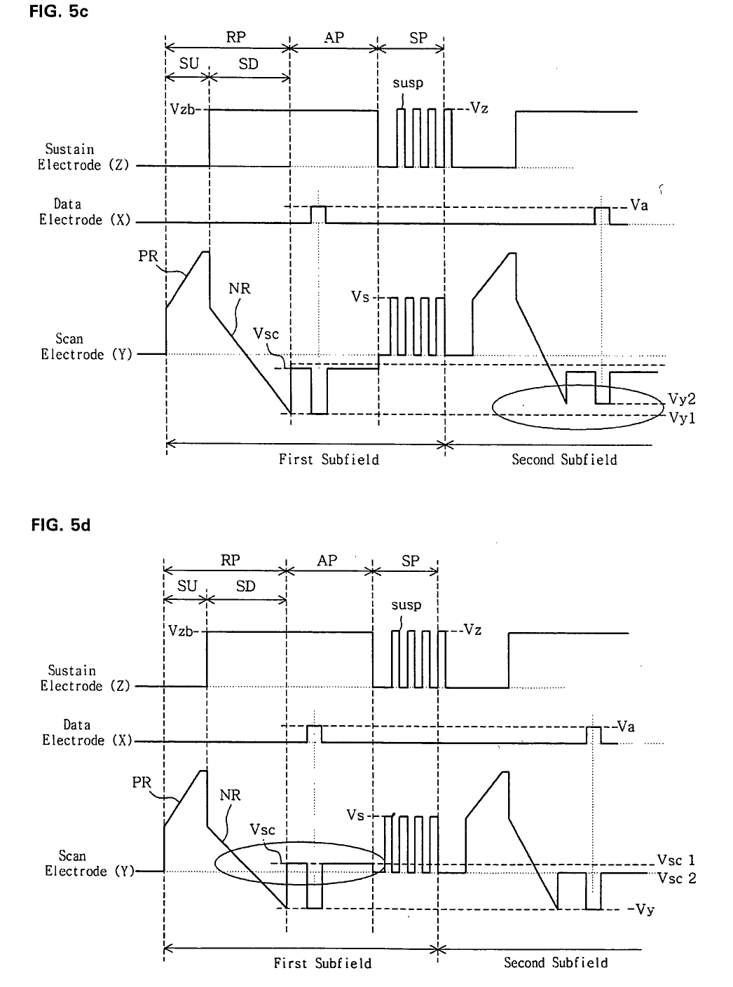

Different from the related art data driver, the data driver 13 according to the embodiment of the present invention controls a magnitude of the data voltage supplied to the data electrodes X1 to Xm. This will be described in detail below with reference to FIG. 5.

Under the control of the control unit 16, the scan driver 14 supplies a reset signal comprising at least one of a rising signal with a gradually rising voltage and a falling signal with a gradually falling voltage to the scan electrodes Y1 to Yn during a reset period so that the whole screen is initialized.

Further, the scan driver 14 supplies a scan reference voltage Vsc and a scan signal, which falls from the scan reference voltage Vsc to a negative level voltage, to the scan electrodes Y1 to Yn during an address period, which follows the reset period, so that scan lines is selected.

The scan driver 14 supplies a sustain signal to the scan electrodes Y1 to Yn during a sustain period so that a sustain discharge is generated within the cells selected in the address period.

Different from the related art scan driver, the scan driver 14 according to the embodiment of the present invention controls a magnitude of the scan bias voltage and a magnitude of the scan voltage. This will be described in detail below with reference to FIG. 4.

Under the control of the control unit 16, the sustain driver 15 supplies a bias voltage of a magnitude equal to a magnitude of a sustain voltage Vs to the sustain electrodes Z during at least a part of the reset period and the address period. Then, the sustain driver 15 supplies a sustain signal to the sustain electrodes Z during the sustain period. At this time, the scan driver 14 and the sustain driver 15 alternately operate.

The control unit 16 receives a vertical/horizontal synchronization signal. The control unit 16 generates timing control signals CTRX, CTRY and CTRZ required in each of the drivers 13, 14 and 15. The control unit 16 supplies the timing control signals CTRX, CTRY and CTRZ to each of the corresponding drivers 13, 14 and 15 to control the drivers 13, 14 and 15. The timing control signals CTRX supplied to the data driver 13 comprises a sampling clock for sampling data, a latch control signal, and a switch control signal for controlling on/off time of an energy recovery circuit and a driving switch element. The timing control signals CTRY supplied to the scan driver 14 comprises a switch control signal for controlling on/off time of an energy recovery circuit installed in the scan driver 14 and a driving switch element. The timing control signals CTRZ supplied to the sustain driver 15 comprises a switch control signal for controlling on/off time of an energy recovery circuit installed in the sustain driver 15 and a driving switch element.

The driving voltage generating unit 17 generates various driving voltages such as a sustain voltage Vs, a scan reference voltage Vsc, a data voltage Va, a scan voltage −Vy, required in each of the drivers 13, 14 and 15. The driving voltages may be changed depending on a composition of a discharge gas or a structure of the discharge cells.

The following is a detail description of a structure of the plasma display apparatus according to the embodiment of the present invention, with reference to the attached drawings.

FIG. 4 illustrates a driver of the plasma display apparatus according to the embodiment of the present invention.

As illustrated in FIG. 4, in the plasma display apparatus according to the embodiment of the present invention, a driver for driving the plasma display panel C will be described in detail below. The driver comprises a sustain voltage supply unit 40, a setup voltage supply unit 41, a scan bias voltage supply unit 42, a driving signal output unit 43 and a scan voltage supply unit 44. The driver further comprises a signal conversion unit 45, an APL (average picture level) unit 46 and a voltage conversion unit 47 to control a driving voltage supplied corresponding to an environment or different driving conditions of the plasma display panel.

The sustain voltage supply unit 40 supplies a sustain signal to the electrode, for example, the scan electrode Y of the plasma display panel in the sustain period.

The setup voltage supply unit 41 supplies a setup voltage Vsetup of the rising signal in the reset signal to the scan electrode Y in the reset period such that the discharge cells of the whole screen are initialized.

The scan bias voltage supply unit 42 supplies a scan bias voltage Vsc to the scan electrode Y in the address period.

The scan voltage supply unit 44 supplies a scan voltage −Vy of the scan signal to the scan electrode Y in the address period. The discharge cells where the address discharge is generated are selected by a sum of the scan voltage −Vy and the data voltage Va supplied to the data electrode X.

The scan bias voltage supply unit 42 and the scan voltage supply unit 44 supply the scan bias voltage Vsc and the scan voltage −Vy in address periods of first and second subfields. The magnitudes of the scan bias voltage Vsc and the scan voltage −Vy supplied in the address period of the first subfield are different from the magnitudes of the scan bias voltage Vsc and the scan voltage −Vy supplied in the address period of the second subfield, respectively. In other words, magnitudes of the scan bias voltage Vsc and the scan voltage −Vy depend on a driving environment of the plasma display panel.

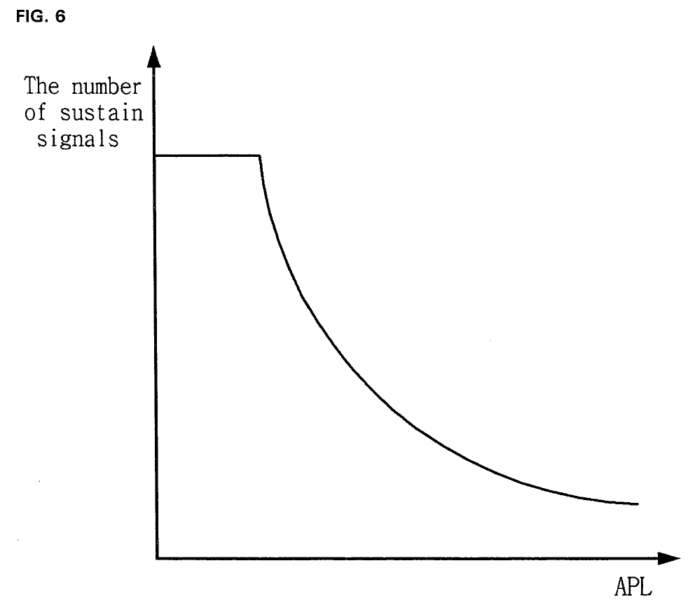

Further, the magnitudes of the scan bias voltage Vsc and the scan voltage −Vy are controlled depending on an APL. This will be described in detail below, with reference to FIG. 6.

A margin of the voltage supplied in the address period changes by various causes such as a line load changed by a location in the whole plasma display panel, a load of the panel depending on the data signal, the APL or a driving temperature of the panel. The embodiment of the present invention solves a problem of an erroneous discharge caused by a change in the voltage margin by selectively controlling a voltage magnitude. As an example of the erroneous discharge, no address discharge is generated. Accordingly, a driving characteristic of the plasma display apparatus according to the embodiment of the present invention is improved by solving the problem of the erroneous discharge.

The driving signal output unit 43 outputs a voltage to the scan electrode Y by its predetermined switching operation.

The signal conversion unit 45 converts an image signal input from the outside into a driving signal for driving the plasma display panel.

The APL unit 46 is used to control the voltages for driving the plasma display apparatus depending on an APL. The APL unit 46 determines the APL depending on the data signal.

The voltage conversion unit 47 converts a voltage magnitude. The voltage conversion unit 47 supplies different magnitudes of the scan bias voltages Vsc in the address periods of the first and second subfields, respectively without a separate voltage supply unit. In other words, the voltage conversion unit 47 supplies different magnitudes of the scan bias voltages Vsc by changing a voltage supplied from the voltage supply unit. The voltage conversion unit 47 may be a DC/DC converter.

The explanation was given of an example of the scan bias voltages Vsc and the san voltage −Vy in the embodiment of the present invention. However, the embodiment of the present invention is not limited thereto. The data voltage supplied to the data electrode X may be controlled. The control of the data voltage will be described in detail below, with reference to FIG. 6.

The embodiment of the present invention is not limited to the above-described driver. In other words, all of driving voltages supplied to the plasma display panel are controlled depending on the environment of the plasma display panel such that the driving characteristic of the plasma display apparatus is optimized.

FIGS. 5a to 5d illustrate first to fourth examples of a driving waveform in the plasma display apparatus according to the embodiment of the present invention;

Referring to FIG. 5a, each of the subfields comprises a reset period RP for initializing all discharge cells on the whole screen, an address period AP for selecting discharge cells to be discharged, and a sustain period SP for discharge maintenance of the selected discharge cells.

In the reset period RP, a rising signal PR is simultaneously supplied to all of the scan electrodes Y during a setup period SU. The rising signal PR generates a weak dark discharge within the discharge cells of the whole screen such that wall charges are accumulated within the discharge cells. The weak dark discharge is called a setup discharge. In a set-down period SD, subsequent to the rising signal PR, a falling signal NR which falls from a positive sustain voltage Vs less than a peak voltage of the rising signal PR to a negative scan voltage −Vy, is simultaneously supplied to the scan electrodes Y. The falling signal NR generates a weak erasure discharge within the discharge cells. The weak erase discharge sufficiently erases the wall charges and space charges excessively accumulated due to the generation of the setup discharge. By performing the weak erase discharge, the wall charges uniformly remain within the discharge cells to the degree that there is the generation of a stable address discharge.

In the address period AP, a scan bias voltage Vsc is supplied to the scan electrodes Y. Further, a scan voltage −Vy of a scan signal of a negative polarity direction is sequentially supplied to the scan electrodes Y. At the same time, a data voltage Va of a data signal of a positive polarity direction synchronized with the scan signal of the negative polarity direction is supplied to the data electrodes X. While a voltage difference between the scan signal and the data signal is added to the wall charges accumulated during the reset period RP, the address discharge is generated within the discharge cells to which the data signal is supplied. Wall charges are accumulated within the discharge cell selected by performing the address discharge.

A positive bias voltage Vzb is supplied to the sustain electrodes Z during the set-down period SD and the address period AP.

In the sustain period SP, a sustain signal SUSP is alternately supplied to the scan electrodes Y and the sustain electrodes Z. While the wall voltage within the cells selected by performing the address discharge is added to the sustain signal SUSP, a sustain discharge of a surface discharge type, that is, a display discharge, is generated between the scan electrodes Y and the sustain electrodes Z whenever the sustain signal SUSP is supplied.

In the embodiment of the present invention, a difference between the scan voltage −Vy or the scan bias voltage Vsc supplied to the scan electrode Y and the data voltage Va supplied to the data electrode X is controlled depending on the subfields. In other words, the difference between the scan voltage −Vy and the data voltage Va or the difference between the scan bias voltage vsc and the data voltage va is controlled depending on the environment of the plasma display panel such as the APL, the driving temperature of the panel, the number of subfields in one frame.

There are various methods for controlling the difference between the scan voltage −Vy and the data voltage Va depending on the subfields. A magnitude of the scan voltage −Vy is maintained at a regular value and a magnitude of the data voltage Va changes. On the contrary, the magnitude of the data voltage Va is maintained at a regular value and the magnitude of of the scan voltage −Vy changes. Further, both the magnitude of the scan voltage −Vy and the magnitude of the data voltage Va change. As a result, the difference between the scan voltage −Vy and the data voltage Va in a subfield of one frame is different from the difference between the scan voltage −Vy and the data voltage Va in another subfield. The various methods for controlling the difference between the scan voltage −Vy and the data voltage Va depending on the subfields are applied to the control of the difference between the scan bias voltage Vsc and the data voltage Va depending on the subfields.

The magnitude of the scan voltage −Vy is controlled in FIG. 5a which is the first example of the driving waveform in the plasma display apparatus. In other words, a scan voltage −Vy1 supplied in the address period of the first subfield is different from a scan voltage −Vy2 supplied in the address period of the second subfield. When the wall charges are sufficiently formed within the discharge cells or the driving margin is relatively large, the scan voltage −Vy2 with a magnitude more than a magnitude of the scan voltage −Vy1 supplied to the first subfield is supplied in the second subfield. Therefore, the plasma display apparatus operates stably. Accordingly, the driving voltage is selectively controlled depending on the environment of the plasma display panel such as the APL, the driving temperature of the panel, the number of subfields of one frame such that the driving margin increases and the driving characteristic is optimized.

FIG. 5b is the second example of the driving waveform in the plasma display apparatus.

The magnitude of the scan bias voltage Vsc is controlled in FIG. 5b. In other words, a scan bias voltage Vsc1 supplied in the address period of the first subfield is different from a scan bias voltage Vsc2 supplied in the address period of the second subfield. When the wall charges are insufficiently formed within the discharge cells or the driving margin is relatively small, the scan bias voltage Vsc is controlled. As a result, a margin of the address discharge is improved and the duration of the address period decreases as comparison with the relater art address period such that a high-speed driving of the plasma display apparatus is realized. Further, the panel yield increases. An erroneous discharge and a no-discharge situation where no discharge is generated are prevented, thereby improving accuracy of the discharge.

In the second example, the driving voltage is selectively controlled depending on the environment of the plasma display panel such as the APL, the driving temperature of the panel, the number of subfields of one frame such that the driving margin increases and the driving characteristic is optimized.

The driving temperature of the panel greatly affects the driving characteristic of the plasma display panel. When the discharge is generated under the driving condition of a high temperature, the wall charges within the discharge cells may be vanished into the space charges at a high speed. Accordingly, the accuracy of the discharge is improved by supplying a driving voltage more than the driving voltage supplied under the driving condition of the high temperature.

FIG. 5c is the third example of the driving waveform in the plasma display apparatus.

The magnitude of the scan voltage −Vy is controlled in FIG. 5c. In other words, a scan voltage −Vy1 supplied in the address period of the first subfield is different from a scan voltage −Vy2 supplied in the address period of the second subfield. When the wall charges are insufficiently formed within the discharge cells or the driving margin is relatively small, the scan voltage −Vy1 with a magnitude more than a magnitude of the scan voltage −Vy2 supplied to the second subfield is supplied in the first subfield. Therefore, the wall charges are sufficiently accumulated. Accordingly, in the third example, the driving voltage is selectively controlled depending on the environment of the plasma display panel such as the APL, the driving temperature of the panel, the number of subfields of one frame such that the driving margin increases and the driving characteristic is optimized.

FIG. 5d is the fourth example of the driving waveform in the plasma display apparatus.

The magnitude of the scan bias voltage Vsc is controlled in FIG. 5d. In other words, a scan bias voltage Vsc1 supplied in the address period of the first subfield is different from a scan bias voltage Vsc2 supplied in the address period of the second subfield. The control of the scan bias voltage Vsc in the fourth example is different from that in the second example. The quantity of wall charges is controlled by controlling the magnitude of the scan bias voltage Vsc.

Accordingly, in the fourth example, the driving voltage is selectively controlled depending on the environment of the plasma display panel such as the APL, the driving temperature of the panel, the number of subfields of one frame such that the driving margin increases and the driving characteristic is optimized.

In the embodiment of the present invention, the first and second subfields are referred to as the subfields with different gray level weights. The magnitudes of the diving voltages are controlled by different diving environments of the subfields, for example, different gray level weights of the subfields, a difference in the number of sustain signals in the subfields. More specifically, the difference between the scan voltage −Vy or the scan bias voltage Vsc and the data voltage Va changes depending on information on the gray level weights of the subfields.

The following is a detailed description of the APL being a factor of the driving environment of the plasma display panel, with reference to FIG. 6.

FIG. 6 illustrates a relationship between an APL and the number of sustain signals in the plasma display apparatus according to the embodiment of the present invention.

As illustrated in FIG. 6, when driving the plasma display panel, the number of sustain signals supplied during the sustain period changes depending on the APL. In other words, the number of sustain signals supplied depending on the APL is controlled in consideration of the sustain signal with a high level voltage, such that power consumption is minimized.

As illustrated in FIG. 6, the maximum number of sustain signals is supplied in the ineffective signal state, where no image data is input (APL=0), and at the low APL. On the other hand, as the APL increases, the number of sustain signals assigned per unit gray scale decreases. In other words, the APL is inversely proportional to the number of sustain signals.

For example, when the image is displayed on a portion with a relatively large area of the screen of the plasma display panel, the power consumption greatly increases. In other words, when the image is displayed on the portion with the relatively large area (at this time, the APL is a relatively high level), the relatively large number of discharge cells participate in the image display. Therefore, by relatively reducing the number of sustain signals per the unit gray scale supplied to each of the discharge cells participating in the image display, the whole power consumption of the plasma display panel decreases.

On the contrary, when the image is displayed on a portion with a relatively small area of the screen of the plasma display panel, the power consumption greatly decreases. In other words, when the image is displayed on the portion with the relatively small area (at this time, the APL is a relatively low level), the relatively small number of discharge cells participate in the image display. Therefore, by relatively increasing the number of sustain signals per the unit gray scale supplied to each of the discharge cells participating in the image display, peak brightness increases and the image quality improves. As described above, the driving method considering the APL improves peak brightness being a drawback of the plasma display panel, such that the whole image quality improves and a rapid increase in the whole power consumption of the plasma display panel is prevented.

Since a load of the plasma display panel changes depending on the APL and the driving margin changes by the change in the load, the selective driving method according to the embodiment of the present invention can be applied thereto.

The driving voltage can be selectively supplied in consideration of the load of the plasma display panel other than the APL. In other words, since the number of sustain signals in the subfields or the subfield mapping changes, the driving voltage, which selectively changes depending on the changes in the driving environment, can be supplied.

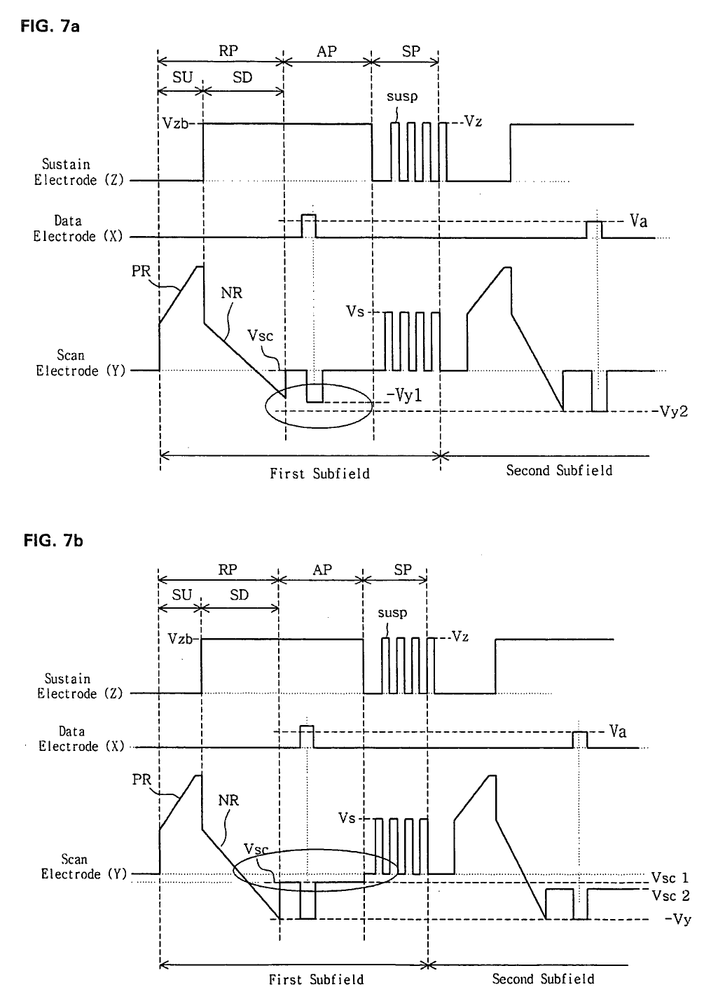

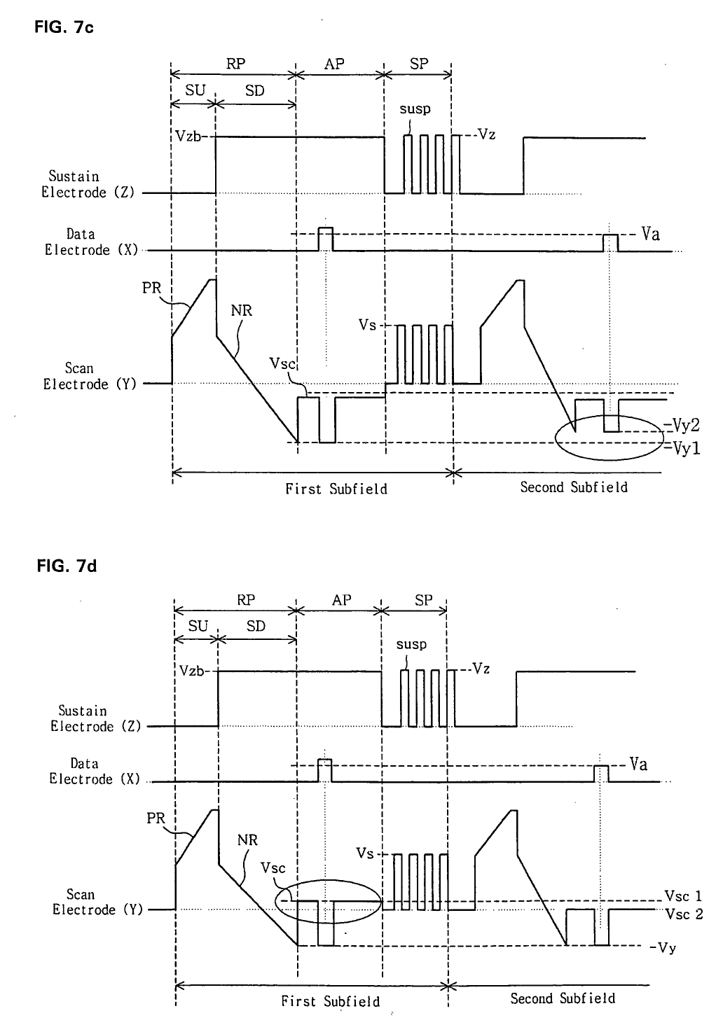

FIGS. 7a to 7d illustrate fifth to eighth examples of a driving waveform in the plasma display apparatus according to the embodiment of the present invention.

Referring to FIG. 7a, each of the subfields comprises a reset period RP for initializing all discharge cells on the whole screen, an address period AP for selecting discharge cells to be discharged, and a sustain period SP for discharge maintenance of the selected discharge cells.

Since the concrete structure of the driving waveform was described in FIG. 5a, a description thereof is omitted. However, the structure of the driving waveform is not limited to the structure illustrated in FIG. 5a.

The data voltage Va is not controlled in the first to fourth examples of FIGS. 5a to 5d. However, the data voltage Va is controlled in the fifth to eight examples of FIGS. 7a to 7d.

A magnitude of the data voltage Va and a magnitude of the scan voltage −Vy are controlled in FIG. 7a which is the fifth example of the driving waveform in the plasma display apparatus. In other words, the data voltage Va and a scan voltage −Vy1 supplied in the address period of the first subfield are different from the data voltage Va and a scan voltage −Vy2 supplied in the address period of the second subfield.

FIG. 7b is the sixth example of the driving waveform in the plasma display apparatus.

A magnitude of the data voltage Va and a magnitude of the scan bias voltage Vsc are controlled in FIG. 7b. In other words, the data voltage Va and a scan bias voltage Vsc1 supplied in the address period of the first subfield are different from the data voltage Va and a scan bias voltage Vsc2 supplied in the address period of the second subfield.

FIG. 7c is the seventh example of the driving waveform in the plasma display apparatus.

A magnitude of the data voltage Va and a magnitude of the scan voltage −Vy are controlled in FIG. 7c. In other words, the data voltage Va and a scan voltage −Vy1 supplied in the address period of the first subfield are different from the data voltage Va and a scan voltage −Vy2 supplied in the address period of the second subfield.

FIG. 7d is the eighth example of the driving waveform in the plasma display apparatus.

A magnitude of the data voltage Va and a magnitude of the scan bias voltage Vsc are controlled in FIG. 7d. In other words, the data voltage Va and a scan bias voltage Vsc1 supplied in the address period of the first subfield are different from the data voltage Va and a scan bias voltage Vsc2 supplied in the address period of the second subfield. A magnitude of the scan bias voltage Vsc1 supplied in the first subfield in FIG. 7d is more than a magnitude of the scan bias voltage Vsc1 supplied in the first subfield in FIG. 7b. The wall charges are controlled by increasing the magnitude of the scan bias voltage Vsc1.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode and a data electrode; and
a scan driver for supplying a scan bias voltage and a scan voltage to the scan electrode,
wherein a magnitude of the scan bias voltage supplied in an address period of a first subfield is different from a magnitude of the scan bias voltage supplied in an address period of a second subfield, and a magnitude of the scan voltage supplied in the address period of the first subfield is different from a magnitude of the scan voltage supplied in the address period of the second subfield.

2. The plasma display apparatus of claim 1, wherein a magnitude of the scan bias voltages and a magnitude of the scan voltages supplied during the address period of the first subfield are different from a magnitude of the scan bias voltages and a magnitude of the scan voltages supplied during the address period of the second subfield depending on an average picture level (APL).

3. The plasma display apparatus of claim 1, further comprising a signal conversion unit for converting an input image signal into a data signal for driving the plasma display panel;
an APL unit for determining an APL depending on the data signal; and
a voltage conversion unit for outputting the scan bias voltage and the scan voltage to the scan driver, wherein the magnitude of the scan bias voltage or scan voltage depends on the APL.

4. The plasma display apparatus of claim 3, wherein the voltage conversion unit comprises a DC/DC converter.

5. A plasma display apparatus comprising:
a plasma display panel comprising a scan electrode and a data electrode; and
a driver for controlling a voltage difference between a scan voltage or a scan bias voltage supplied to the scan electrode and a data voltage supplied to the data electrode in an address period of a first subfield to be different from a voltage difference between a scan voltage or a scan bias voltage supplied to the scan electrode and a data voltage supplied to the data electrode in an address period of a second subfield.

6. The plasma display apparatus of claim 5, wherein a magnitude of the difference between the scan voltage or the scan bias voltage and the data voltage in the address period of the first subfield, and a magnitude of the difference between the scan voltage or the scan bias voltage and the data voltage in the address period of the second subfield depend on an APL.

7. The plasma display apparatus of claim 5, wherein a magnitude of the difference between the scan voltage or the scan bias voltage and the data voltage in the address period of the first subfield, and a magnitude of the difference between the scan voltage or the scan bias voltage and the data voltage in the address period of the second subfield depend on a temperature.

8. The plasma display apparatus of claim 5, wherein a magnitude of the difference between the scan voltage or the scan bias voltage and the data voltage in the address period of the first subfield, and a magnitude of the difference between the scan voltage or the scan bias voltage and the data voltage in the address period of the second subfield depend on the number of subfields in one frame.

9. The plasma display apparatus of claim 5, wherein a magnitude of the scan voltage supplied during the address period of the first subfield equals to a magnitude of the scan voltage supplied during the address period of the second subfield, or a magnitude of the scan bias voltage supplied during the address period of the first subfield equals to a magnitude of the scan bias voltage supplied during the address period of the second subfield.

10. The plasma display apparatus of claim 5, wherein a magnitude of the data voltage supplied during the address period of the first subfield equals a magnitude of the data voltage supplied during the address period of the second subfield.

11. The plasma display apparatus of claim 5, further comprising a signal conversion unit for converting an input image signal into a data signal for driving the plasma display panel;
an APL unit for determining an APL depending on the data signal; and
a voltage conversion unit for changing the voltage difference between the scan voltage or the scan bias voltage and the data voltage depending on the APL.

12. The plasma display apparatus of claim 11, wherein the voltage conversion unit comprises a DC/DC converter.

13. A plasma display apparatus comprising:
a plasma display panel comprising a scan electrode and a data electrode;
a scan driver for supplying a scan bias voltage and a scan voltage to the scan electrode, wherein a magnitude of the scan bias voltage supplied during the address period of the first subfield is different from a magnitude of the scan bias voltage supplied in the address period of the second subfield, and a magnitude of the scan voltage supplied in the address period of first subfield is different from a magnitude of the scan voltage supplied in the address period of second subfield depending on an APL; and
a data driver for supplying a data voltage to the data electrode, wherein a magnitude of the data voltage supplied during the address period of the first subfield is different from a magnitude of the data voltage supplied during the address period of the second subfield depending on the APL.

14. A method of driving a plasma display apparatus comprising a scan electrode and a data electrode, comprising:
controlling a voltage difference between a scan voltage or a scan bias voltage supplied to the scan electrode and a data voltage supplied to the data electrode in an address period of a first subfield to be different from a voltage difference between a scan voltage or a scan bias voltage supplied to the scan electrode and a data voltage supplied to the data electrode to in an address period of a second subfield.

15. The method of claim 14, wherein a magnitude of the difference between the scan voltage or the scan bias voltage and the data voltage in the address period of the first subfield, and a magnitude of the difference between the scan voltage or the scan bias voltage and the data voltage in the address period of the second subfield depend on an APL.

16. The method of claim 14, wherein a magnitude of the difference between the scan voltage or the scan bias voltage and the data voltage in the address period of the first subfield, and a magnitude of the difference between the scan voltage or the scan bias voltage and the data voltage in the address period of the second subfield depend on a temperature.

17. The method of claim 14, wherein a magnitude of the difference between the scan voltage or the scan bias voltage and the data voltage in the address period of the first subfield, and a magnitude of the difference between the scan voltage or the scan bias voltage and the data voltage in the address period of the second subfield depend on the number of subfields in one frame.

18. The plasma display apparatus of claim 14, wherein a magnitude of the scan voltage supplied during the address period of the first subfield equals to a magnitude of the scan voltage supplied during the address period of the second subfield, or a magnitude of the scan bias voltage supplied during the address period of the first subfield equals to a magnitude of the scan bias voltage supplied during the address period of the second subfield.

19. The method of claim 14, wherein a magnitude of the data voltage supplied during the address period of the first subfield equals a magnitude of the data voltage supplied during the address period of the second subfield.

20. The method of claim 14, further comprising calculating a gray level weight corresponding to an input image signal; and
changing the difference between the scan voltage or the scan bias voltage and the data voltage depending on the gray level weight.
